(19) United States
(12) Patent Application Publication
(10) Pub. No.: US 2004/0130695 A1
(43) Pub. Date: Jul. 8, 2004

(54) Kit for converting a photolithography machine for treating semiconductor wafers of certain diameter to a machine for treating semiconductor wafers of larger diameter

(76) Inventor: Vyacheslav Ananyev, San Francisco, CA (US)

Correspondence Address: Vyacheslav Ananyev, 39 Ardenwood Way, San Francisco, CA, 94132, US

(21) Appl. No.: 10/337,630

(22) Filed: Jan. 8, 2003

(51) Int. Cl. G03B 27/58

(52) U.S. Cl. 355/72; 355/76; 355/53

(57) ABSTRACT

The conversion kit of the invention is intended for converting an existing photolithographic machine for treating semiconductor wafers of a predetermined size to a machine for treating semiconductor wafers of a larger size. This is achieved without changing the basic parameters, characteristics, and dimensions of the existing machine and without the need of purchasing an expensive new machine. The kit of the invention consists of the following main replaceable parts and units listed in the direction of movement of the wafer through the machine: a notch-orientation unit for preliminary alignment of a wafer with a predetermined position of the notch; a wafer floating support for supporting the wafer on air cushion; a mechanical arm for transferring wafers between the wafer floating support and a wafer chuck; a wafer chuck for holding and securing the wafer during alignment, e.g., by vacuum; a calibration plate unit with a moveable calibration plate required for setting a wafer at a precise distance from the mask surface and with precise parallelism relative thereto; an outlet tray for transfer of the treated wafer from the wafer chuck to a receiving cassette. Some kit components are standard parts and units commercially produced for the lithographic machine of the larger size or of the next generation. Other parts are slightly modified and resized.

### FIELD OF THE INVENTION

The present invention relates to the semiconductor manufacture equipment, in particular to a kit for converting an existing photolithography machine for treating semiconductor substrates of a predetermined range of diameters to a machine for treating semiconductor substrates of a larger diameter.

### BACKGROUND OF THE INVENTION

Photolithographic technology involves the process of transferring a pattern on a mask into a photosensitive photoresist coated onto a substrate. The mask is usually a quartz or glass plate with one side coated, e.g., with a thin opaque chrome layer. To form a desired pattern on the mask, portions of the chrome layer are precisely removed to form a complex pattern of transparent and opaque areas. In the microelectronics industry, this pattern represents a microcircuit. In the micro-optics industry, this pattern represents optical waveguides or a diffraction grating. The goal of photolithography is to precisely transfer the mask pattern into the photoresist, which is coated onto the substrate. The two categories of photolithography generally used in conventional practice are projection lithography and contact lithography. Projection lithography involves the use of a lens to image the mask pattern onto the surface of the photoresist. Devices used to achieve projection lithography are called steppers. Contact lithography involves direct contact between the mask and the photoresist. Devices used to achieve contact lithography are called mask aligners.

The alignment and contact printing process in photolithographic equipment includes several steps. The mask is placed in a photomask holder. The article to be patterned, or wafer, is placed on a vacuum chuck, which includes a plate having holes in it. When the article is placed on a surface of the vacuum chuck, it is held in place by suction through the holes in the plate. The hard mask is then positioned above, and parallel to, the wafer, within several hundred microns. A prealignment is performed wherein one or more alignment patterns on the hard mask are brought into registration with one or more corresponding alignment patterns on the surface of the article. Depending on the geometry of the corresponding patterns, one or two pairs of alignment patterns are sufficient to bring the stamp-printing pattern into registration with the overall wafer pattern. One or two pairs of alignment patterns are sufficient to provide alignment regardless of the size of the mask because the mask is rigid. The alignment is accomplished by detecting the relative positions of the alignment patterns and making the necessary adjustments in the position of the hard mask and/or wafer by making x-y adjustments and angular/rotational adjustments in position. Alignment detection is achieved by using an alignment microscope. One or, at most, two alignment microscopes are included to detect alignment of the pair(s) of alignment patterns. When alignment is achieved, the hard mask and article are brought into contact. The printing gap between the mask and wafer is about 0-50 micrometers: hard contact is achieved by providing a high vacuum between the mask and wafer; soft contact is achieved by providing a low vacuum, about 50-500 mm Hg. It is recognized in the art that abrupt pressure change to vacuum conditions can trap gas between the mask and wafer. However, the solution is generally a step change from large-gap/high-pressure to soft-contact/low pressure followed by a delay for gas release through a valve; thereafter, hard-contact/vacuum are provided by dialing in the desired distance and, optionally, by flowing a stream of inert gas, at a given flow rate, from the underside of the wafer on the wafer chuck. These step changes in the distance between the wafer and mask and in the pressure of the gas between them are sufficient to prevent gas bubble formation between a hard mask and wafer.

Existing contact-type mask aligners are still unable to reproduce sharp mask lines with the width smaller than 1 micrometer. This is because direct (1:1) contact transfer of an image of the mask into the material of the resist is accompanied by diffraction distortions. The aforementioned problem cannot be eliminated even by reducing the wavelength of the source light by utilizing, e.g., an ultraviolet light source, because the microgap between the surfaces of the mask and resist cannot be reduced below a certain limit. Therefore in a majority of cases the latest LSI and VLSI circuits are produced with the use of projection-type photolithography tools with a projection ratio of (5:1) or (10:1). By using light source of a short wavelength, such as 193 nanometers or 157 namometers and masks of special types (phase-shifting masks), the projection-type photolithography machines make it possible to reproduce in the resists lines with a width of 0.12 micrometer or even narrower.

However, a modern projection-type photolithographic machine is more than from 10 to 30 times more expensive than a conventional contact-type photolithographic machine. On the other hand, there exist an enormous amount of electronic devices with patterns that can be reproduced with the use of only contact-type photolithography. Examples of the aforementioned electronic devices are the following: integrated circuits of a low and intermediate degree of integration with the design rule (line width) no less than 3 micrometer; various integration optical devices; microsensors; intellectual microsensors with small chips; devices for microbiology, etc.

Development of electronic and semiconductor industries have been accompanied by mass production of mask aligners of the direct-contact type, which were produced in thousands of units. In particular, the direct-contact type photolithography machines were developed in a number of successive generations, each dependent on a specific diameter of a semiconductor wafer. An example of a typical existing photolithographic machine of the aforementioned type is a PLA-501F machine produced by Canon Corporation. During the age of 5″ silicone substrates, this particular machine found a very wide practical application in the semiconductor industry. At the present time, however, the 5″ substrates are almost completely replaced by the substrates of larger diameters, i.e., 6″, 8″, and greater. Therefore, an enormous park of existing 5″ machines, which are unsuitable for treating substrates of a diameter exceeding 5″, appeared to be inefficient and underused.

In order to satisfy the modern demands of the industry, new 6″ machines were developed by resealing the 5″ machines. Examples of such proximity and contact type machines are a PLA-600FA machine produced by Canon and MA-6 produced by KarlSuss for wafer size 6″. It is appreciated that these machines are much more expensive and complicated in structure than the 5″ machines.

### SUMMARY OF THE INVENTION

It is an object of the invention to provide a kit for converting a photolithography machine to larger diameter wafers without changing the basic dimensions of an existing lithographic machine. It is another object to improve the wafer transportation mechanism for unloading the treated wafers from the chuck to the receiving cassette. Still another object is to rearrange a mask-holder bearing unit of the photolithographic machine in order to accommodate a larger-size mask. A further object is to provide a simplified spring-loaded mechanism for elimination of an axial play in the mask-holder bearings. Another object is to provide a conversion kit for converting a 5″ photolithography machine into a 6″ photolithography machine. A specific object of the invention is to provide a kit for converting a Canon PLA-501F type into a Canon PLA-600FA machine.

The conversion kit of the invention is intended for converting an existing photolithographic machine for treating semiconductor wafers of a predetermined size to a machine for treating semiconductor wafers of a larger size. This is achieved without changing the basic parameters, characteristics, and dimensions of the existing machine and without the need of purchasing an expensive new machine. The kit of the invention consists of the following main replaceable parts and units listed in the direction of movement of the wafer through the machine: a notch-orientation unit for preliminary alignment of a wafer with a predetermined position of the notch; a wafer floating support for supporting the wafer on air cushion; a mechanical arm for transferring wafers between the wafer floating support and a wafer chuck; a wafer chuck for holding and securing the wafer during alignment, e.g., by vacuum; a calibration plate unit with a moveable calibration plate required for setting a wafer at a precise distance from the mask surface and with precise parallelism relative thereto; an outlet tray for transfer of the treated wafer from the wafer chuck to a receiving cassette. Some kit components are standard parts and units commercially produced for the lithographic machine of the larger size or of the next generation. Other parts are slightly modified and resized.

### BRIEF DESCRIPTION OF THE DRAWINGS

FIG. 1 is a simplified three-dimensional view of a notch-orientation unit and wafer-transfer unit used in an existing wafer-manufacturing photolithographic machine with a mask holder stage removed for clarity of the drawing.

FIG. 2 is a top view of the notch-orientation unit of the known machine.

FIG. 3 is a vertical cross section through the gap unit of the machine of FIG. 1.

FIG. 4 is a simplified three-dimensional view of a notch-orientation unit and wafer-transfer unit used in the wafer-manufacturing photolithographic machine with a mask holder stage removed for clarity of the drawing.

FIG. 5 is a top view of the notch-orientation assembly of the invention.

FIG. 6 is a vertical cross section through the gap unit of the machine of FIG. 4.

FIG. 7 is a cross section through the mask holder stage of the invention in the diagonal direction of the mask.

FIGS. 8 and 9 are partial cross-sectional views illustrating various embodiments of axial play compensation elements for elimination of an axial play in the thrust-bearing unit of the mask holder stage.

FIG. 10 is a top view on a part of the trough for transporting the wafers from the chuck to the wafer-receiving cassette.

### DETAILED DESCRIPTION OF THE INVENTION

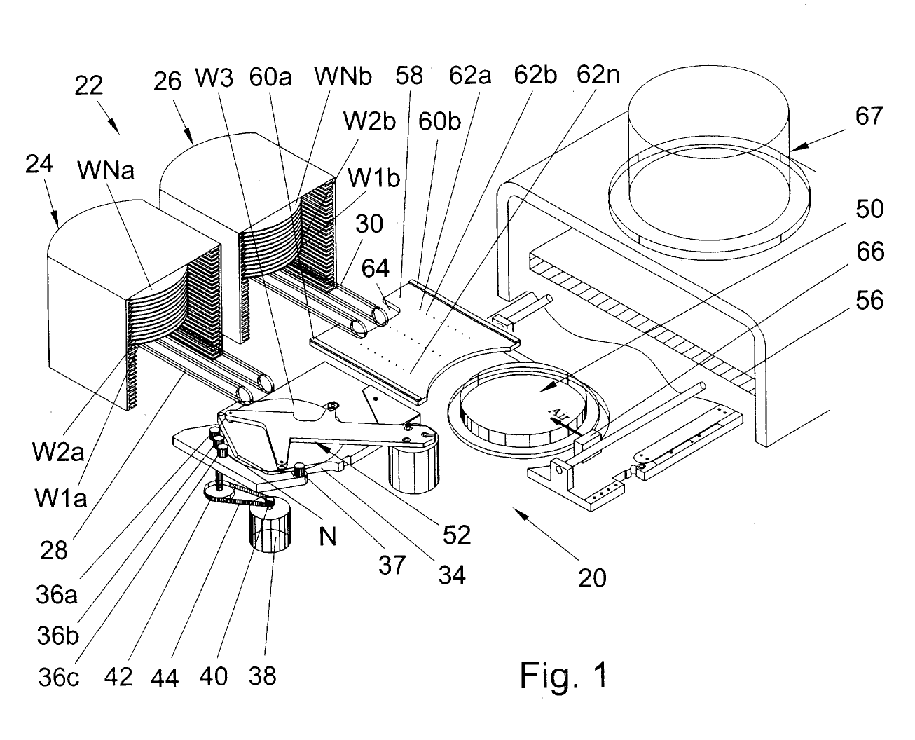

For better understanding the principle of the invention, let us first consider a typical existing photolithographic machine, e.g., a machine of the PLA-501F type produced by Canon Corporation. FIG. 1 is a simplified three-dimensional view of an alignment unit used in the aforementioned photolithographic machine. A mask holder stage is not shown for clarity of the drawing.

The machine, which is shown in FIG. 1 and in general is designated by reference numeral 20, consists of a number of units, which will now be described in a sequence corresponding to the direction of movement of a semiconductor wafer W through the machine.

Reference numeral 22 designates an auto-feeder that consists of a wafer-feeding cassette 24 and a wafer-receiving cassette 26. Each cassette is served via a respective belt conveyor 28 and 30 for unloading untreated wafer and for receiving treated wafers, respectively. The auto-feeder 22 has a conventional construction known in the art and is beyond the scope of the present invention. It should only be noted that in the design of the auto-feeder 22 shown in FIG. 1 the rack with untreated wafers W1a, W2a, . . . . Wna moves in a downward vertical direction for unloading the lowermost wafer onto the unloading conveyor belt 28, while the rack with treated wafers moves in the upward vertical direction for inserting the treated wafers W1b in the empty cells of the wafer-receiving cassette 26.

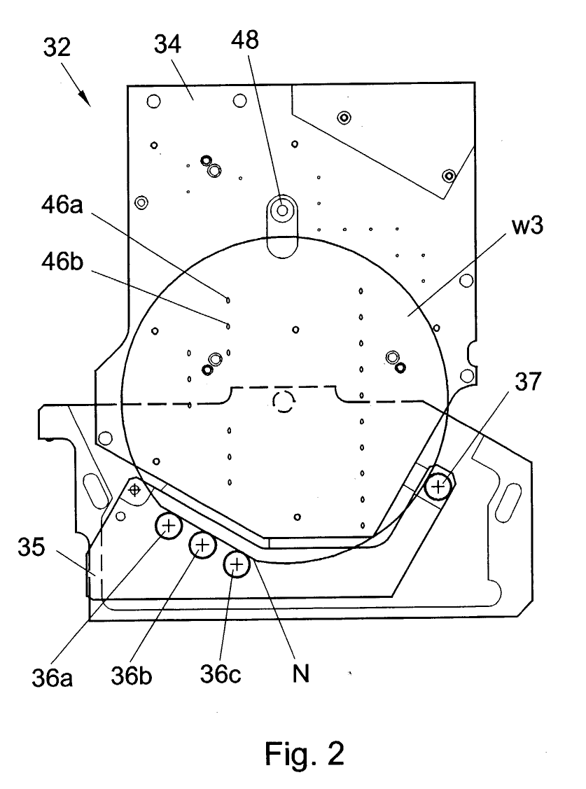

Reference numeral 32 designates a notch-orientation unit for preliminary orientation of wafer's notch N in a predetermined position of the wafer (the notch N is shown in the wafer W3, which at the moment shown in FIG. 1 is located in the notch-orientation unit 32). A specific orientation of the notch N is required for transfer of the wafer to a subsequent operation in a right position. The top view of the notch-orientation unit 32 is shown in FIG. 2. This unit consists of a perforated wafer floating support 34, which mounts an angular plate 35 (FIG. 2). Another friction roller 37, which is also installed on the angular plate 35, is an idle roller. When a wafer is loaded into the notch-orientation unit 32, the circular part of the wafer's periphery comes into contact with two rollers, one of which is the roller 37 and another is the one from the group 36a, 36b, 36c of the drive rollers, which are arranged in line. The rollers 36a, 36b, 36c may be driven in rotation from a DC motor 38 via a pulleys 40 and 42 and an endless belt 44 (FIG. 1) and are in friction contact with the wafer for imparting rotation thereto. At the moment, when the wafer W3 assumes the position shown FIGS. 1 and 2 with the notch N in the position tangential to the rollers, the rotation of the rollers 36a, 36b, 36c is stopped, and the wafer W3 is secured in the oriented position by means of an additional roller 48 (FIG. 2). The roller 48 pops up under the command generated in a central processing unit of the machine (not shown) synchronously with stopping of the rollers 36a, 36b, and 36c.

The notch-orientation unit 32 has perforations 46a, 46b, . . . 46n (FIG. 2) connected to a compressed air line (not shown) and intended for generation of an air cushion in order to provide a floating condition of the wafer during pre-alignment.

A wafer chuck 50 (FIG. 1) of the machine is located under a mask holder stage (not shown in FIGS. 1 and 2 and described in detail later) in the path of the wafers between the wafer-receiving cassette 26 and the notch-orientation unit, and a mechanical arm 52, which transfers the wafers is provided between the notch-orientation unit 32 and the chuck 50. The mechanical arm 52 is a conventional rotary-type mechanical arm with an end effector for handling semiconductor wafers.

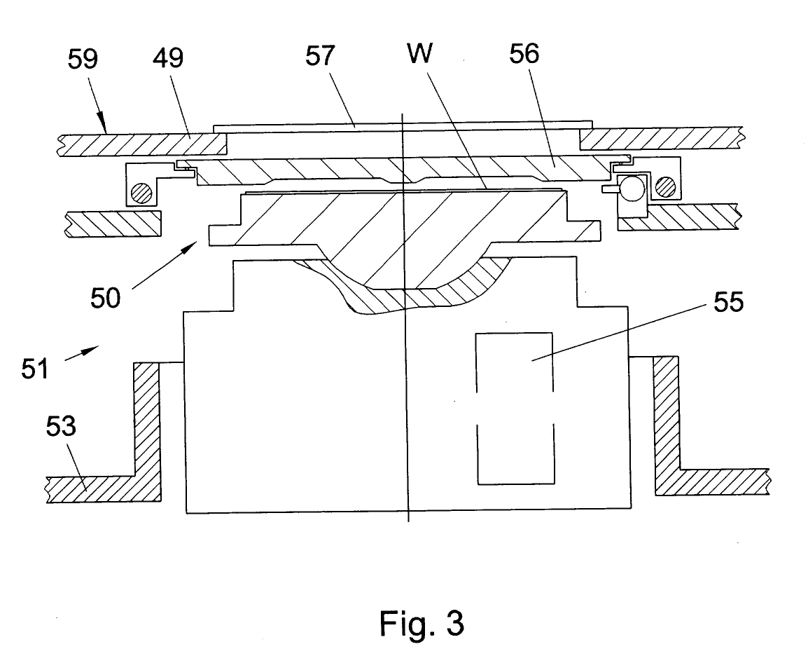

The wafer chuck 50 of the known machine is installed on a so-called gap unit 51, which is shown in a vertical cross section in FIG. 3. The gap unit 51, in turn, rests on a support frame 53 moveable in a horizontal plane along two mutually-perpendicular axes X and Y in order to ensure alignment of the wafer, held in the chuck 50, relative to the mask. The supports of the moveable frame 53 are not shown. In addition, by means of the aforementioned gap unit 51, the chuck 50 can be shifted in a vertical direction from a motor 55 via a transmission mechanism (not shown) for forming a predetermined gap between the mask and the wafer surface required for contact-free arrangement and movement of the mask relative to the wafer. The wafer chuck 50 is connected to a vacuum system (not shown) for securing the wafer in the chuck during operation.

Located above the chuck is a mask holder stage 54, which is shown in FIG. 1 only partially, in order not to cover the chuck and other essential parts of the machine. The mask holder stage 54 comprises a metal frame, which rotatingly supports a replaceable ring-shaped mask-holder plate 49 with a central opening for access of the wafer chuck 50 to the mask (not shown in FIG. 1) supported by the mask holder stage 54. For this purpose, the aforementioned central opening exceeds the outer diameter of the chuck 50.

The machine is provided with a calibration plate 56 located sidewise with respect to the chuck 50 and the mask holder stage 54 and aligned with the gap between the upper surface of the chuck 50 and the lower surface of the mask holder stage 54 so that the calibration plate can be introduced into the aforementioned gap. When it is necessary to calibrate the distance and parallelism between the wafer W on the chuck 50 and the mask holder stage 54, the calibration plate 56 is introduced into the gap between the wafer W on the chuck and the holder, the chuck is lifted till contact of the wafer W with the lower surface of the calibration plate and is fixed in this position. The calibration plate 56 is then withdrawn from the gap.

The wafers are unloaded from the wafer chuck 50 to the wafer-receiving cassette 26 through an unloading trough 58 with parallel linear side guides 60a and 60b spaced from each other for a distance slightly exceeding diameter of the wafer W. The trough 58 has perforations 62a, 62b, . . . 62n connected though an appropriate air-distribution system to the same compressed air source (not shown) as the perforations 36a, 36b, . . . 36n of the notch-orientation unit 32. This is necessary for supporting the wafer during transportation to the belt conveyor 30 on an air cushion. As shown in FIG. 1, the receiving end of the belt conveyor 30 is inserted into a cut-out 64 formed on the leading edge of the trough 58.

Reference numeral 67 designates an exposure unit of a 5″ machine. This unit is not necessarily produced by Cannon and may comprise any exposure unit that generates a light beam sufficient to cover a 5″ semiconductor wafer.

The known apparatus operates as follows:

A wafer W1a is unloaded from the wafer-feeding cassette 24 of the auto-feeder 22 onto the conveyor belt 28, which transports the wafer W1a to the notch-orientation unit 32. Due to contact of the wafer periphery with one of the rotating rollers 36a, 36b, 36c . . . and an idle friction roller 37, rotation is transmitted to the wafer Wa1. The wafer rotates until the notch N (FIG. 2) assumes the position shown in FIG. 1, i.e., when the edge of the notch N is in contact with all linearly arranged rollers 36a, 36b, 36c. At the moment shown in FIG. 2, the rotation of the rollers 36a, 36b, 36c is stopped for maintaining the wafer in an appropriate position pre-aligned for the transfer of the wafer to the chuck 50.

Meanwhile, a photo mask 57 shown in FIG. 3 is placed in a photomask holder stage 54. The wafer W1a to be patterned is placed on a vacuum chuck 50. When the wafer is placed on the surface of the vacuum chuck 50, it is held in place by suction through the holes 46a, 46b, . . . in the bottom plate of the chuck (FIGS. 2 and 3). The calibration plate 56 is then inserted into the space between the surface of the wafer W1a in the chuck 50 and the lower surface of the mask holder stage 54. The wafer chuck 50, which has a floating support on a spherical bearing (not shown) is self-aligned with respect to the mask holder, and the aligned position is fixed by vacuum generated inside the spherical bearing. The distance between the mask and the wafer is remembered and stored in the memory of the control unit. The wafer chuck 50 is slightly cleared from the calibration plate 56 in order to free the calibration plate for removal from the space between the chuck 50 and the mask holder stage 54. The calibration plate is removed, and the wafer chuck 50 is raised to the working position, in which a predetermined gap on the order of several micrometers is formed between the lower surface of the mask 57 and the upper surface of the wafer W1a. Now angular alignment is performed by bringing the marks on the mask in registration with the marks on wafer. Depending on the geometry of the corresponding patterns, one or two pairs of alignment patterns are sufficient to bring the stamp printing pattern into registration with the overall wafer pattern. One or two pairs of alignment patterns are sufficient to provide alignment regardless of the size of the mask 57 because the mask is rigid. The alignment is accomplished by detecting the relative positions of the alignment patterns and making the necessary adjustments in the position of the hard mask and/or wafer by making x-y adjustments and angular/rotational adjustments in position. This is achieved due to ability of the mask-supporting unit to freely move in the X-Y plane. Alignment detection is achieved by using an alignment binocular microscope (not shown). One or, at most, two alignment binocular microscopes are included to detect alignment of the pair(s) of alignment patterns. When alignment is achieved, the hard mask 57 and the wafer are brought into contact.

After alignment is completed, the image of the patterns of the mask 57 is transferred to the wafer via exposure, and the processed wafer, which is now a wafer W1b, is released from the chuck by eliminating vacuum and ejecting the wafer from the chuck by a flow air blown from a separate lateral air nozzle unit 66 (FIGS. 1 and 3), which has a nozzle orifice aligned with the edge of the wafer W in chuck.

Under the effect of the air flow emitted from the nozzle unit 66, the wafer W1b is shifted onto the unloading trough 58 (FIG. 1) with the parallel linear side guides 60a and 60b. Air jets emitted through the perforations 62a, 62b, . . . 62n provide a floating support on the wafer in an air cushion during transportation along the linear guides 60a and 60b and by means of the conveyor belt 30 towards the wafer-receiving cassette 26.

Thus, it has been shown that the conventional photolithographic exposure machine, in particular the aforementioned PLA-501F machine produced by Canon, is designed for treating semiconductor wafer only of a 5″ diameter or smaller. In order to process semiconductor wafers having a diameter of 6″ or greater, a new machine designed for wafer of 6″ or greater has to be purchased. As the industry has transferred to wafers having diameters of 6″ and greater, a number of machines and devices for accompanying processes have been designed to match wafers having 6″ as the minimal diameter. Examples of such machines and units are the following: etching machines, dielectric coating machined, dielectric sputtering machines, etc.

In the context of the present invention, the term “larger size machine” designates a photolithographic alignment and contact/proximity exposure machine for treating wafers having a diameter of 6″ or greater.

The conversion kit of the invention will now be described with reference to the aforementioned PLA-501F type produced by Canon Corporation. It is understood, however, that this specific machine is given as an example only. It also is understood that some parts and units of the conversion kit of the invention for converting a 5″-size machine into a 6″-size machine comprise standard and commercially produces parts that can be purchased from the parts list of the larger-diameter machine, e.g., the PLA-600FA machine produced by Canon. An example of such units is a wafer chuck. In other words, the conversion kit of the invention consists of both standard parts and units commercially produced for a larger-size machine and parts and units newly designed to fit into the existing basic 5″ machine. In the following description, the parts and units of the larger size machine similar to those of the 5″ machine will be designated by the same reference numerals with the addition of 100. For example, the wafer chuck of the larger-size machine will be designated by reference numeral 150, the wafer unloading magazine will be designated by reference numeral 124, etc.

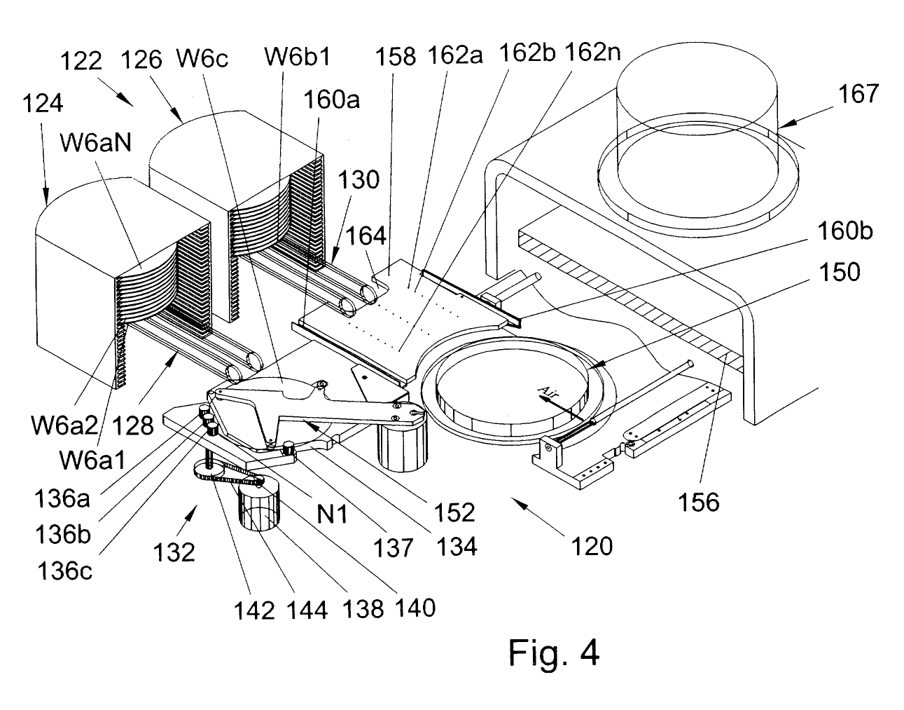

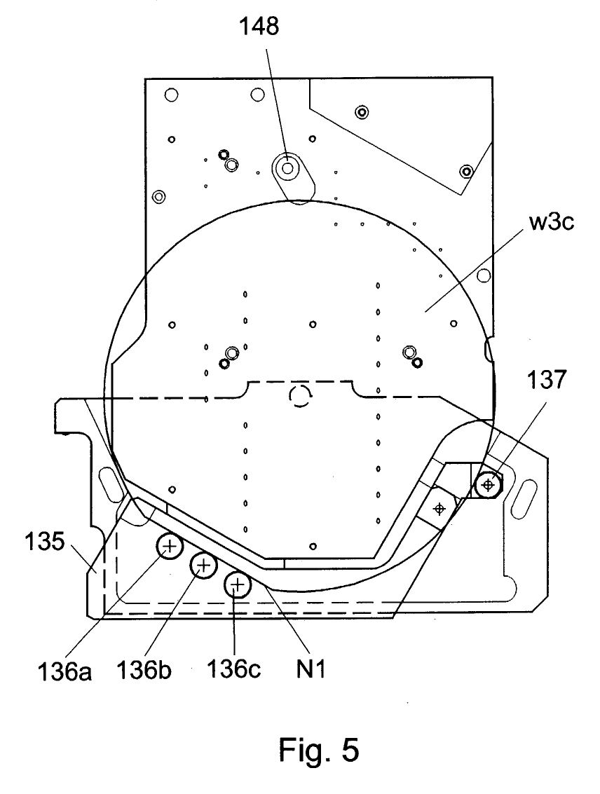

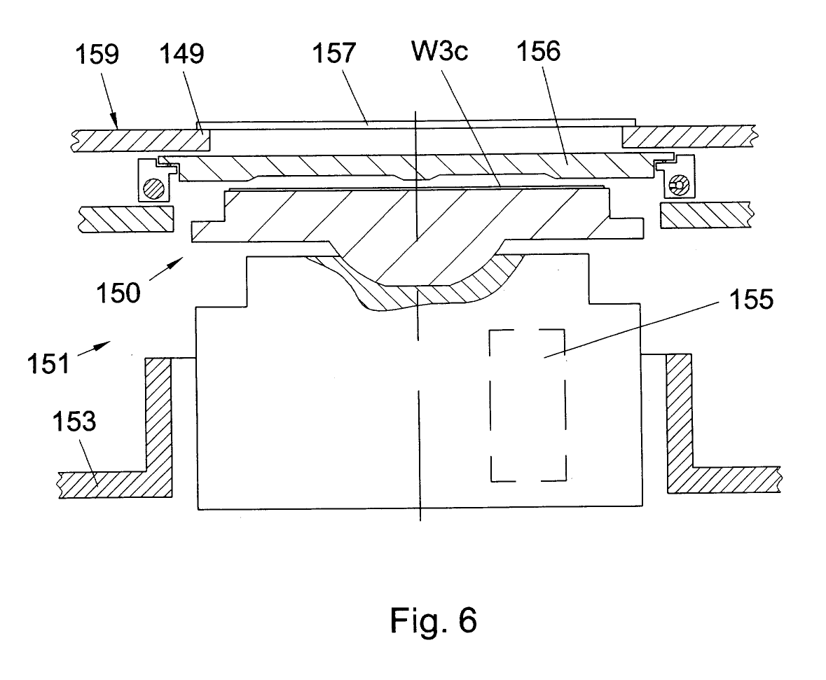

FIG. 4 is a simplified three-dimensional view of a notch-orientation unit and wafer-transfer unit of the machine of the present invention. FIG. 5 is a top view of the notch-orientation assembly of the invention. FIG. 6 is a vertical cross section through the gap unit of the machine of FIG. 4.

A larger size machine produced by conversion from the 5″ machine by means of the conversion kit of the invention is shown in FIG. 4, which is a general three-dimensional view of the machine. In general this machine is designated by reference numeral 120. It consists of a number of units, which will now be described in sequence corresponding to the direction of movement of a semiconductor wafer W6″ through the machine.

Reference numeral 122 designates an auto-feeder that consists of a wafer-feeding cassette 124 and a wafer-receiving cassette 126. Each cassette is designed for loading/unloading wafers having 6″ diameter. This size is given as an example and is chosen for the case of conversion from 5″ wafer to 6″ wafer. The auto-feeder 122 is served via a respective belt conveyor 128 and 130 for unloading untreated and for receiving treated wafers, respectively. The auto-feeder 122 has a conventional construction known in the art and is beyond the scope of the present invention. It should only be noted that in the design of the auto-feeder 122 shown in FIG. 4 the rack with untreated wafers W6a₁, W6a₂, . . . W6aₙ moves in a downward vertical direction for unloading the lowermost wafer onto the unloading conveyor belt 128, while the rack with treated wafers moves in the upward vertical direction for inserting the treated wafers W6b₁, . . . into the empty cells of the wafer-receiving cassette 126.

Reference numeral 132 designates a notch-orientation unit for preliminary orientation of wafer's notch N1 in a predetermined position of the wafer (the notch N1 is shown in the wafer W6c, which at the moment shown in FIG. 4 is located in the notch-orientation unit 132). The specific orientation of the notch N1 is required for transfer of the wafer to subsequent operation in a right position. The top view of the notch-orientation unit 132 is shown in FIG. 5. This unit consists of a perforated wafer floating support 134, which mounts an angular plate 135 (FIG. 5). Another friction roller 137, which is also installed on the angular plate 135, is an idle roller. In fact, the notch-orientation unit has the same construction as the notch orientation unit 32 of the 5″ machine and differs from it only by the resealing to a larger size to mach 6″ wafers. When a wafer is loaded into the notch-orientation unit 132, the circular part of the wafer's periphery comes into contact with two rollers, one of which is the roller 137 and another is the one from the group 136a, 136b, 136c of the drive rollers, which are arranged in line. The rollers 136a, 136b, 136c may be driven in rotation from a DC motor 138 via a pulleys 140 and 142 and an endless belt 144 (FIG. 4) and are in friction contact with the wafer for imparting rotation thereto. At the moment, when the wafer W3c assumes the position shown FIGS. 4 and 5 with the notch N1 in the position tangential to the rollers, the rotation of the rollers 136a, 136b, 136c is stopped, and the wafer W3c is secured in the oriented position by means of an additional roller 148 (FIG. 5). The roller 148 pops up under the command generated in a central processing unit of the machine (not shown) synchronously with stopping of the rollers 136a, 136b, 136c.

The notch-orientation unit 132 has perforations 146a, 146b, . . . 146n (FIG. 5) connected to a compressed air line of the basic 5″ machine (not shown) and intended for generation of an air cushion in order to provide a floating condition of the wafer during orientation of the notch.

A wafer chuck 150 (FIG. 4) of the machine is a standard unit commercially produced for 6″ machines. It is located under a mask holder stage (not shown in FIGS. 4 and 5 and described in detail later) in the path of the wafers between the wafer-receiving cassette 126 and the notch-orientation unit, and a mechanical arm 152, which transfers the wafers, is provided between the notch-orientation unit 132 and the chuck 150. The mechanical arm 152 is a conventional rotary-type mechanical arm with an end effector for handling semiconductor wafers.

The wafer chuck 150 of the known 6″ machine is installed on a so-called gap unit 151, which is shown in a vertical cross section in FIG. 6. The gap unit 151, in turn, rests on a support frame 153 moveable in a horizontal plane along two mutually-perpendicular axes X and Y in order to ensure alignment of the wafer, held in the chuck 150, relative to the mask. The supports of the moveable frame 153 are not shown. In addition, by means of the aforementioned gap unit 151, the chuck 150 can be shifted in a vertical direction from a motor 155 via a transmission mechanism for forming a predetermined gap between the mask and the wafer surface required for contact-free arrangement and movement of the mask relative to the wafer. The wafer chuck 150 is connected to a vacuum system of the basic 5″ machine (not shown) for securing the wafer in the chuck during operation.

Located above the chuck 150 is a mask holder stage 154, which is shown in FIG. 4 only partially, in order not to cover the chuck and other essential parts of the machine. The mask holder stage 154 of the invention is modified from the conventional configuration in order to fit into the space available in the 5″ machine. More specifically, the diameter of the mask holder plate 149 was increased for accommodating the larger diameter mask, and the bearing unit, consisting of two thrust bearings, was rearranged in order to leave the frame unchanged. Furthermore, the helical axial play compensation springs, which occupied a significant space and required the use of a large number of additional parts, were replaced by a springing ring element that supports the balls of the lower bearing.

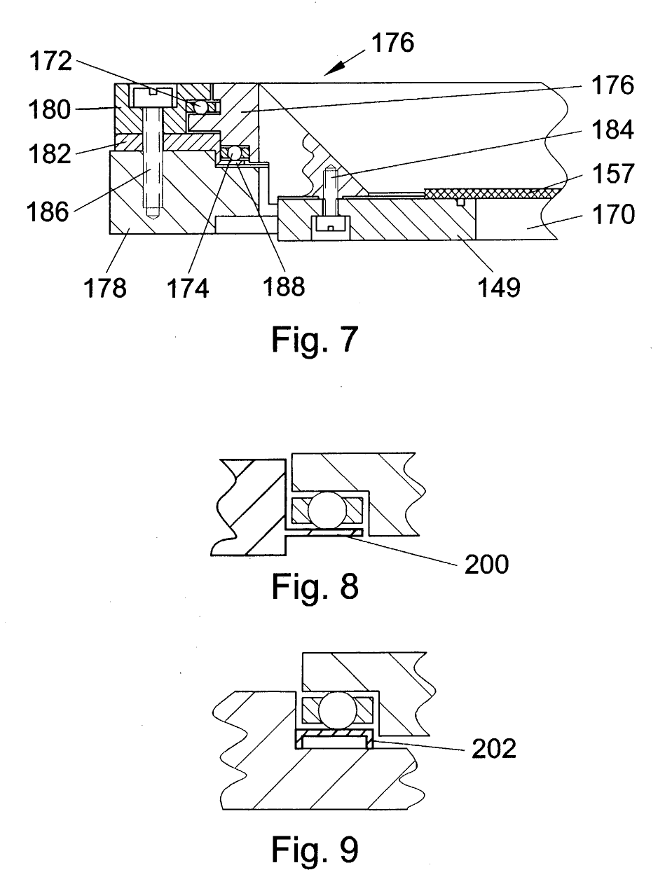

FIG. 7 is a cross section through the mask holder stage 154 in the diagonal direction of the mask. The mask holder stage 154 comprises a metal frame, which rotatingly supports a replaceable ring-shaped mask-holder plate 149 with a central opening 170 for access of the wafer chuck 150 to the mask 157 supported by the mask holder plate 149. For this purpose, the aforementioned central opening exceeds the outer diameter of the chuck 150.

In FIG. 7, reference numerals 172 and 174 designate thrust bearings for rotatingly supporting the mask holder plate 149 with an inner ring 176 relative to a frame 178, an outer ring 180 and an intermediate flexible spacer 182. In order to provide room for the mask holder plate 157 of a larger diameter than the mask holder plate 57 of the smaller diameter machine, the bearings 172 and 172 are moved radially outwardly from the position of the respective bearings of the 5″ diameter machine, and the radial distance of the bearing 172 from the center of rotation of the mask holder stage is greater than the respective radial distance of the bearing 174. The inner ring 176 and the mask holder plate 149 are rigidly connected to each other, e.g., by bolts, such as a bolt 184 (FIG. 7). The inner ring 176 and the mask holder plate 149 are rotating parts. The outer ring 180, the intermediate flexible spacer 182, and the frame 178 are rigidly interconnected, e,g., by bolts, such as a bolt 186. The last-mentioned parts are stationary.

In order to compensate for axial play in the bearing 172 and 174, the balls of the bearing 174 ride over a flexible race ring 188, in which the ball supporting element is made from a spring steel and for flexibility may have a cantilever support edge or a U-shaped configuration. The cantilever bearing play compensator with the cantilever support edge 200 is shown in FIG. 8, while the U-shaped bearing support element 202 is shown in FIG. 9. Both FIGS. 8 and 9 are partial cross-sectional views illustrating the axial play compensation elements.

The machine is provided with a calibration plate 156 located sidewise with respect to the chuck 152 and the mask holder stage 154 and aligned with the gap between the upper surface of the chuck 150 and the lower surface of the mask holder 154 so that the calibration plate can be introduced into the aforementioned gap. When it is necessary to calibrate the distance and parallelism between the wafer W1c on the chuck 152 and the mask holder stage 154, the calibration plate 156 is introduced into the gap between the wafer W1c on the chuck 150 and the mask holder plate 149, the chuck is lifted till contact of the wafer W1c with the lower surface of the calibration plate and is fixed in this position. The calibration plate 56 is then withdrawn from the gap.

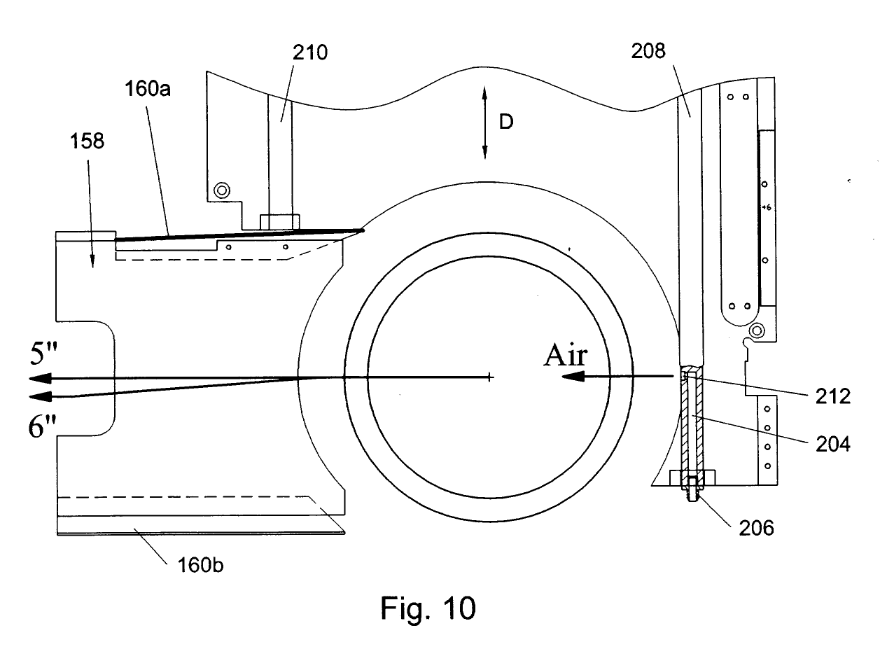

The wafers are unloaded from the wafer chuck 150 to the wafer-receiving cassette 126 through an unloading trough 158 with side guides 160a and 160b spaced from each other for a distance slightly exceeding diameter of the wafer W. The arrangement of the side guides 160a and 160b differs from that of the smaller diameter machine in that they are not parallel to each other. More specifically, as shown in FIG. 10, which is a top view on a part of the trough 158, in order to prevent interference of the larger-diameter wafer with some parts of the exiting 5″ machine, the nozzle unit 66 of the smaller-diameter machine is removed and is replaced by an air channel 204 connected to a compressed air line of the existing machine via a pipe unit 206 and formed in a rear guide plate 208, which together with a front guide plate 210 forms a calibration plate guide unit. The calibration plate 156 (FIG. 4), which is guided in the guide plates 208 and 210 in the direction of the arrow D, is not shown in FIG. 10. The outlet orifice 212 of the air channel is aligned with the edge of the wafer W1c in the wafer chuck and is used for shifting the treated wafer from the chuck 150 towards the wafer receiving cassette 126 through the trough 158 with perforations 162a, 162b, . . . 162n connected though an appropriate air-distribution system to the same compressed air source (not shown) as the perforations 36a, 36b, . . . 36n of the notch-orientation unit 32. This is necessary for supporting the wafer during transportation to the belt conveyor 130 on an air cushion. As shown in FIG. 4, the receiving end of the belt conveyor 130 is inserted into a cut-out 164 formed on the leading edge of the trough 158.

Reference numeral 167 designates an exposure unit commercially produced for 6″ machine. This unit is not necessarily produced by Cannon and may comprise any exposure unit that generates a light beam sufficient to cover a 6″ semiconductor wafer.

The trough 158 of the conversion kit of the invention differs from the trough 58 of the smaller diameter machine by the fact that it is shifted toward the wafer-receiving cassette for a distance required to provide room for the larger-diameter wafer and in that the side guide plates 160a and 160b are not strictly parallel and change the path of movement of the wafer from the chuck to the cassette from strictly straight-linear to a non-linear.

Thus it can be concluded that the conversion kit of the invention contains the following parts and units which have construction different from the similar parts and units of the smaller diameter machine: the calibration plate guide unit, in particular the rear guide 208; a later air blow nozzle formed by the channel 204 and the orifice 212 in the rear guide 208; the bearing unit of the mask holder formed by the outer ring 180, an inner ring 176, the bearings 172 and 174; an axial play elimination ring 178 that presses the bearings 172 and 174 towards the respective support surfaces into a gap-free state; and the side guide plates 160a and 160b for guiding the wafers from the chuck to the wafer-receiving cassette 126. The remaining parts of the kit are either merely rescaled or commercially produced for the larger diameter machine.

The wafer alignment and exposure machine of the smaller diameter converted into the larger-diameter machine with the use of the conversion kit of the invention operates exactly in the same manner as has been described above with reference to the existing small-diameter machine with the only difference that after the treated wafer W1c is freed from the vacuum chuck 150, it is shifted towards the transportation trough 158 by the flow of air ejected through the orifice 212 and in that the wafer W1c is guides on air cushion along a non-linear trajectory between the guide plates 160a and 160b. The axial play in the bearing unit of the mask holder is eliminated by the springing action of the play elimination element 200 or 202.

Thus it has been shown that the invention provides a kit for converting a photolithography machine for wafers of a certain diameter to a machine for wafers of a larger diameter without changing the basic dimensions of the existing photolithographic machine. The kit improves the wafer transportation mechanism for unloading the treated wafer from the chuck to the receiving cassette, rearranges a mask-holder bearing unit of the mask holder in order to accommodate a larger-size mask, and simplifies a spring-loaded mechanism for elimination of an axial play in the mask-holder bearings.

The invention has been shown and described with reference to specific embodiments, which should be construed only as examples and do not limit the scope of practical applications of the invention. Therefore any changes and modifications in technological processes, constructions, materials, shapes, and their components are possible, provided these changes and modifications do not depart from the scope of the patent claims. For example, though the invention was exemplified by a conversion kit for conversion from 5″ machine to 6″ machine, the same principle can be applicable for conversion from 6″ machine to a machine for treating wafers having diameters greater than 6″. The notch-orientation mechanism may have a construction different from the one shown in FIG. 5. The mechanical arm, wafer cassettes, wafer chuck, mask holder, and other parts and units may have shapes and structures different from those shown and described with reference to FIGS. 5-10 and can be made from different materials than that in the modified or commercially produced parts and units.

The axial play compensation mechanism may comprise a spring washer. The guide plates 160a and 160b can be replaceable or made as part of the trough. A wafer chuck may be of a type different from a vacuum-type chuck, e.g., of an electrostatic type.

1. A kit for converting a photolithography machine for treating semiconductor wafers of a certain diameter to a machine for treating semiconductor wafers of a larger diameter, comprising:
a commercially produced semiconductor wafer chuck for said semiconductor wafers of a larger diameter;
a commercially produced notch-orientation unit of said machine for treating semiconductor wafers of a larger diameter;
a mask holder stage redesigned for said machine for treating semiconductor wafers of a larger diameter and intended for holding a mask with a pattern for a larger diameter mask, said mask holder stage comprising: a mask holder plate with a central opening having a diameter sufficient for the access of said semiconductor wafers of a larger diameter to said mask; a stationary frame installed on said mask holder stage; a rotating ring which is rigidly connected to said mask holder plate; a bearing unit for rotatingly supporting said rotating ring with said mask holder plate on said stationary frame; and an axial play elimination member for eliminating an axial play in said bearing unit, said wafer chuck having means for moving in a vertical direction; and said mask holder stage having means for moving in a horizontal plane in an X-Y direction;
a calibration plate unit for calibrating a working distance and parallelism between said mask and said semiconductor wafer of a larger diameter during alignment and exposure, said calibration plate unit comprising: a calibration plate moveable in the lateral direction of said calibration plate unit and insertable into a space between said mask and said semiconductor wafer of a larger diameter in said wafer chuck; and guide plate unit consisting of a front guide plate and a rear guide plate;
a wafer transportation trough for transporting said semiconductor wafers of a larger diameter away in a transporting operation from said wafer chuck after completion of said alignment and exposure, said wafer transportation trough being provided with means for generating an air cushion under said semiconductor wafer of a larger diameter during said transporting operation; and
a wafer shifting mechanism for shifting said semiconductor wafer of a larger diameter away from said wafer chuck onto said wafer transportation trough comprising a compressed air channel formed in said rear guide plate and an air blow orifice formed in said rear guide for generating an air blow directed towards an edge of said semiconductor wafer.

2. The kit of claim 1, wherein said wafer transporting trough comprises a first side guide plate and a second side guide plate arranged in the direction of said transporting and provided with means for generating an air cushion under said semiconductor wafer of a larger diameter during said transporting operation, said first side guide plate and a second side guide plate having means for guiding said wafer of a larger diameter along a non-linear trajectory for performing said transporting operation in a space available in said photolithography machine for treating semiconductor wafers of a certain diameter.

3. The kit of claim 2, wherein said bearing unit comprises an outer ring member rigidly attached to said stationary frame and having a portion located above said bearing unit and in contact therewith, said axial play elimination member comprising a flexible member that constantly presses said bearing unit towards said portion of said located above said bearing unit.

4. The kit of claim 3, wherein said flexible member comprises a ring member made from a material with springing properties, said bearing unit being in contact with said flexible member and is compressed between said stationary frame and said rotating ring so that said flexible member is compressed.

5. The kit of claim 1, wherein said photolithography machine for treating semiconductor wafers of a certain diameter comprises a 5″ wafer-diameter machine and wherein said machine for treating semiconductor wafers of a larger diameter is a 6″ wafer-diameter machine.

6. The kit of claim 5, wherein said 5″ wafer-diameter machine is a machine selected from the group consisting of a Canon PLA-501F photolithography machine and a Canon PLA-501FA photolithography machine, and wherein said 6″ wafer-diameter machine is a Canon PLA-600 photolithography machine.

7. The kit of claim 2, wherein said photolithography machine for treating semiconductor wafers of a certain diameter comprises a 5″ wafer-diameter machine and wherein said machine for treating semiconductor wafers of a larger diameter is a 6″ wafer-diameter machine.

8. The kit of claim 7, wherein said 5″ wafer-diameter machine is a machine selected from the group consisting of a Canon PLA-501F photolithography machine and a Canon PLA-501FA photolithography machine, and wherein said 6″ wafer-diameter machine is a Canon PLA-600 photolithography machine.

9. The kit of claim 3, wherein said photolithography machine for treating semiconductor wafers of a certain diameter comprises a 5″ wafer-diameter machine and wherein said machine for treating semiconductor wafers of a larger diameter is a 6″ wafer-diameter machine.

10. The kit of claim 9, wherein said 5″ wafer-diameter machine is a machine selected from the group consisting of a Canon PLA-501F photolithography machine and a Canon PLA-501FA photolithography machine, and wherein said 6″ wafer-diameter machine is a Canon PLA-600 photolithography machine.

11. The kit of claim 4, wherein said photolithography machine for treating semiconductor wafers of a certain diameter comprises a 5″ wafer-diameter machine and wherein said machine for treating semiconductor wafers of a larger diameter is a 6″ wafer-diameter machine.

12. The kit of claim 11, wherein said 5″ wafer-diameter machine is a machine selected from the group consisting of a Canon PLA-501F photolithography machine and a Canon PLA-501FA photolithography machine, and wherein said 6″ wafer-diameter machine is a Canon PLA-600 photolithography machine.

13. The kit of claim 1, further comprising a wafer auto-feeder for said wafers of a larger diameter and an exposure unit for said wafers of a larger diameter.

14. The kit pf claim 11, further comprising a wafer auto-feeder for said 6″ wafers and an exposure unit for said 6″ wafers.

15. A kit for converting a photolithography machine for treating semiconductor wafers of a certain diameter to a machine for treating semiconductor wafers of a larger diameter, comprising:
a set of parts and units selected from a group consisting of parts and units commercially produced for said machine for treating semiconductor wafers of a larger diameter and a set of parts of said photolithography machine for treating semiconductor wafers of a certain diameter, which are rescaled for said machine for treating semiconductor wafers of a larger diameter without changes in the construction; and
a set of redesigned parts, which are redesigned specifically for use in conjunction with said machine for treating semiconductor wafers of a larger diameter.

16. The kit of claim 15, wherein said set of parts and units selected from the group consisting of parts and units commercially produced for said machine for treating semiconductor wafers of a larger diameter and a set of parts which are rescaled for said machine for treating semiconductor wafers of a larger diameter without changes in the construction comprises:
a semiconductor wafer chuck for said semiconductor wafers of a larger diameter;
a notch-orientation unit of said machine for treating semiconductor wafers of a larger diameter;
a wafer-transfer mechanical arm for transfer of said semiconductor wafer of a larger diameter between said notch-orientation unit and said wafer chuck;
a wafer auto-feeder for said wafers of a larger diameter; and
an exposure unit for said wafers of a larger diameter; and
wherein said set of redesigned parts comprises a mask holder stage redesigned for holding a mask with a pattern for a larger diameter mask; a calibration plate unit for calibrating a working distance and parallelism between said mask and said semiconductor wafer of a larger diameter during alignment and exposure; a wafer transportation trough for transporting said semiconductor wafers of a larger diameter away in a transporting operation from said wafer chuck after completion of said alignment and exposure.

17. The kit of claim 16, wherein said mask holder stage comprising: a mask holder plate with a central opening having a diameter sufficient for the access of said semiconductor wafers of a larger diameter to said mask; a stationary frame installed on said mask holder stage; a rotating ring which is rigidly connected to said mask holder plate; a bearing unit for rotatingly supporting said rotating ring with said mask holder plate on said stationary frame; and an axial play elimination member for eliminating an axial play in said bearing unit, said wafer chuck having means for moving in a vertical direction; and said mask holder stage having means for moving in a horizontal plane in an X-Y direction;
said calibration plate unit comprising: a calibration plate moveable in the lateral direction of said calibration plate unit and insertable into a space between said mask and said semiconductor wafer of a larger diameter in said wafer chuck; and guide plate unit consisting of a front guide plate and a rear guide plate;
said wafer transportation trough being provided with means for generating an air cushion under said semiconductor wafer of a larger diameter during said transporting operation; and
said wafer shifting mechanism comprising a compressed air channel formed in said rear guide plate and an air blow orifice formed in said rear guide for generating an air blow directed towards an edge of said semiconductor wafer.

17. The kit of claim 17, wherein said wafer transporting trough comprising a first side guide plate and a second side guide plate arranged in the direction of said transporting and provided with means for generating an air cushion under said semiconductor wafer of a larger diameter during said transporting operation, said first side guide plate and a second side guide plate having means for guiding said wafer of a larger diameter along a non-linear trajectory for performing said transporting operation in a space available in said photolithography machine for treating semiconductor wafers of a certain diameter.

18. The kit of claim 17, wherein said bearing unit comprises an outer ring member rigidly attached to said stationary frame and having a portion located above said bearing unit and in contact therewith, said axial play elimination member comprising a flexible member that constantly presses said bearing unit towards said portion of said located above said bearing unit.

19. The kit of claim 18, wherein said flexible member comprises a ring member made from a material with springing properties, said bearing unit being in contact with said flexible member and is compressed between said stationary frame and said rotating ring so that said flexible member is compressed.

20. The kit of claim 15, wherein said photolithography machine for treating semiconductor wafers of a certain diameter comprises a 5″ wafer-diameter machine and wherein said machine for treating semiconductor wafers of a larger diameter is a 6″ wafer-diameter machine.

21. The kit of claim 20, wherein said 5″ wafer-diameter machine is a machine selected from the group consisting of a Canon PLA-501F photolithography machine and a Canon PLA-501FA photolithography machine, and wherein said 6″ wafer-diameter machine is a Canon PLA-600 photolithography machine.

22. The kit of claim 19, wherein said flexible member comprises a ring member made from a material with springing properties, said bearing unit being in contact with said flexible member and is compressed between said stationary frame and said rotating ring so that said flexible member is compressed.

23. The kit of claim 22, wherein said photolithography machine for treating semiconductor wafers of a certain diameter comprises a 5″ wafer-diameter machine and wherein said machine for treating semiconductor wafers of a larger diameter is a 6″ wafer-diameter machine.
